(19) United States
(12) Patent Application Publication
(10) Pub. No.: US 2010/0102045 A1
(43) Pub. Date: Apr. 29, 2010

(54) METHOD OF CUTTING PARTS TO BE MACHINED USING A PULSED LASER

(75) Inventor: Ulrich Dürr, Allmendigen (CH)

Correspondence Address: GRIFFIN & SZIPL, PC, SUITE PH-1, 2300 NINTH STREET, SOUTH, ARLINGTON, VA, 22204, US

(73) Assignee: LASAG AG, Thun (CH)

(21) Appl. No.: 12/525,657

(22) PCT Filed: Feb. 6, 2008
(86) PCT No.: PCT/EP2008/051463

§ 371 Date: Aug. 3, 2009

(30) Foreign Application Priority Data
Dec. 13, 2007 (EP) 07102270

(51) Int. Cl. B23K 26/38

(52) U.S. Cl. 219/121.72

(57) ABSTRACT

The invention relates to a method for cutting parts (4) to be machined, using a pulsed laser (6) that outputs a beam (12) of laser pulses. The method is characterised in that a given cut is carried out using a single laser pulse, essentially for forming an opening (14) in the machined part. To this end, the method comprises a quick relative movement between the part and the laser beam (12) with a pulse duration that is sufficiently long, depending on the relative movement, so that the laser beam can run at least on the predetermined length for a given cut. Each laser pulse preferably has an initial power peak for piercing the machined part when the cutting operation is carried out in an inner region of the part.

International Patent Application PCT/EP2008/051463 filed Feb. 6, 2008, which claims priority on European Patent Application No. 07102270.1 of Feb. 13, 2007 and international Application PCT/EP2008/051463 of Feb. 6, 2008. The entire disclosures of the above patent applications are hereby incorporated by reference.

### FIELD OF THE INVENTION

The present invention concerns the field of laser cutting parts to be machined and in particular machining apertures in such parts. One particular application concerned by the present invention is cutting tubes that have a diameter of several millimetres. Generally, the invention concerns cutting parts where the length of the cutting line is between several millimetres and several dozen millimetres.

### BACKGROUND OF THE INVENTION

The use of lasers outputting a continuous wave (CW-lasers) for performing clean clear cuts is limited, since the power of such lasers is limited and any increase in power (for example between 10 and 20 KW) is very expensive. Therefore one can practically only cut very thin sheets.

The use of pulsed lasers for cutting parts to be machined, in particular metallic or ceramic parts, is also known to those skilled in the art. Pulsed lasers can easily produce high power pulses. In order to make a cut several millimetres long cut in a part to be machined, in particular to form an aperture in such a part, pulsed-laser cutting is performed by a series of more or less oblong and partially superposed holes, in order to make the desired cut. This conventional method thus cannot produce perfectly clean cuts that have a contour with no unevenness or slight waviness. Indeed, the series of holes formed by the successive laser pulses make it difficult to obtain, for example, a perfectly rectilinear or circular cut, given that the energy provided by the laser beam is not constant along the cutting line. As the amount of energy varies along the cutting line, the width of the resulting defect varies in accordance with the energy. The wall generated by laser cutting thus has some waviness or roughness. It will be noted that the higher the cutting speed, the less clean and uniform the cutting contour. Since the frequency of the laser pulses is limited, the cutting speed is also limited in order to maintain a certain quality.

It is an object of the present invention to overcome the problem linked to the aforementioned drawbacks, by providing a cutting method using a pulsed laser beam that can perform very clean cuts, in particular apertures with an approximately smooth wall.

The use of a pulsed laser enables mean powers to be obtained for each relatively high pulse with respect to the mean laser power. Relatively high power is necessary to make clean cuts, particularly in a metallic or ceramic part with a certain thickness, for example of several dozen millimetres.

### SUMMARY OF THE INVENTION

The present invention therefore concerns a method of cutting a part using a pulsed laser that outputs a beam formed of laser pulses, this method being characterized in that a complete cut is made in said part entirely by one of said laser pulses and by a rapid relative movement between said part and said laser beam, said pulse length being sufficiently long with respect to said relative movement for said laser beam to travel at least the desired length of said cut.

In order to be able to make a cut of a certain length using a single laser pulse, according to the invention relatively long laser pulses are generated with a length of more than a millisecond and preferably of the order of magnitude of 10 ms (milliseconds) or more, particularly between 10 and 100 ms. Preferably, an installation that allows high speed relative movement will be chosen, of the order of magnitude of 10 m/min (metres per minute) or more. Implementation of the method of the invention thus provides a complete cut along one line or one contour measuring up to several dozen millimetres at each laser pulse. Of course, the present invention is not limited to cuts of relatively long length, but can also advantageously be applied to cuts of smaller length, particularly of the order of magnitude of a millimetre.

In a preferred implementation of the laser machining method according to the invention, the power profile of the laser pulses generated by the laser installation is modulated to optimise cutting and obtain a cutting line of approximately constant thickness. In particular, there is a peak of initial power for performing the initial piercing in the part to be machined when the machining does not start along an edge of the part. Then, in a variant, the pulse body following the initial peak is also modulated to obtain a constant supply of energy along the cutting line or contour, particularly as a function of the provided various curves.

The method according to the invention allows a series of apertures to be continually made, i.e. allowing the part to be machined to move at a given speed in accordance with the frequency of the laser pulses, which have a determined length so as to each make an aperture.

### BRIEF DESCRIPTION OF THE DRAWINGS

The present invention will be described below in more detail with reference to the annexed drawings, in which:

FIG. 1 shows schematically a first laser machining installation for implementing the method according to the invention, applied to cutting apertures in a part;

FIG. 2 shows schematically a second laser machining installation for implementing the method according to the invention;

FIG. 3 shows schematically a nozzle with a large aperture of particular shape adapted to cutting with the second installation;

FIG. 4 shows schematically a particular machining head forming a variant of the second installation;

FIGS. 5A and 5B show two variants of the laser pulse power profile according to the invention;

FIG. 6 shows schematically a laser machining installation for cutting a tube in accordance with the method of the invention.

### DETAILED DESCRIPTION OF THE ILLUSTRATIVE EMBODIMENTS

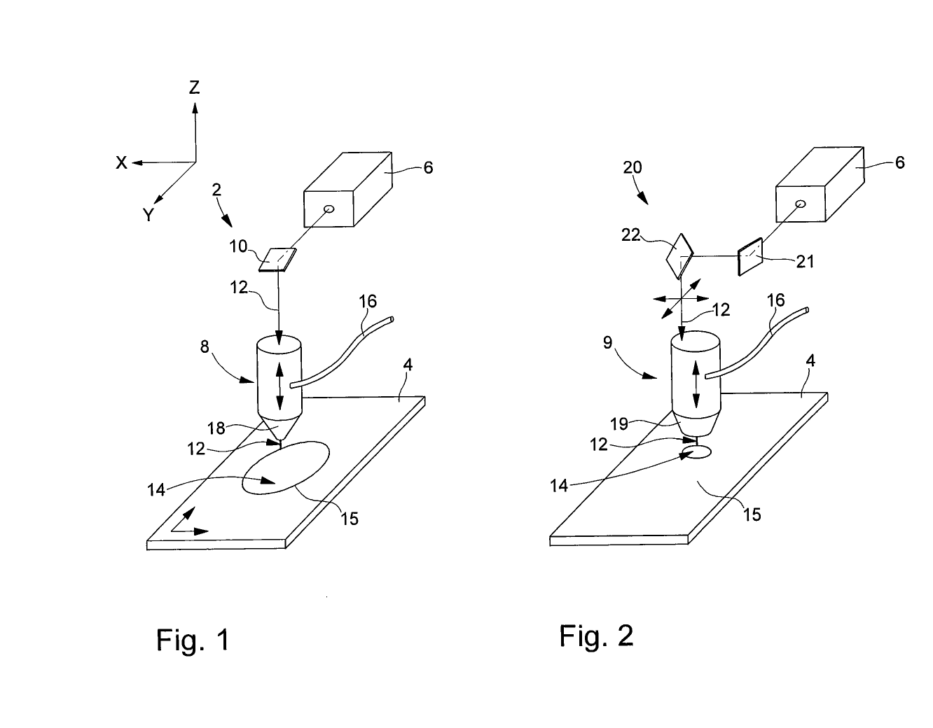

FIG. 1 shows a laser installation 2 for implementing the method according to the present invention. The laser installation is shown entirely schematically with a laser source 6, a mirror 10 used for deviating the laser beam supplied by source 6 in the direction of the machining head 8 which includes, in particular, optical focussing means for the laser beam. Installation 2 is arranged for performing cuts in plates or parts to be machined 4. In the example given here, the laser beam 12 exiting the machining head 8 is used for making apertures 14 in part 4. Head 8 is only mobile along the vertical axis, whereas part 4 undergoes a horizontal movement relative to the head. Part 4 is thus arranged in a digitally controlled machining installation, which generates a controlled horizontal movement of part 4. It will be noted that parts can be cut in a plate in the same way whatever the contour of the parts.

Within the scope of the present invention, the laser 6 chosen is a pulsed type laser, i.e. it generates a series of laser pulses.

According to the invention, the cutting of each aperture 14 or each cut part is performed by a single laser pulse supplied by laser source 6. Thus, unlike the method of the prior art, the cut along contour 15 that defines the edge of aperture 14 is performed within the length of a single pulse, and not via a series of pulses that generate a series of more or less oblong holes. As already mentioned, this technique provides clean, precise cuts with a cut slot of constant width. Thus, the resulting wall of aperture 14 is smooth and the cut edge defining the edge of aperture 14 does not have any projecting parts or waviness.

In order to make a cut within a single laser pulse length, pulses are generated with a relatively long pulse length, of more than a millisecond. For some applications, the pulse length is preferably greater than 10 milliseconds and may be up to 200 milliseconds. This latter value is not a maximum value that limits the scope of the present invention. It will be noted that for several applications in which the method according to the invention is particularly efficient and innovative, the laser pulse length is approximately between 10 and 100 ms. For small cutting lengths, smaller pulse lengths can obviously be used. However, within the scope of the present invention, the pulse length is greater than 1 ms to allow the laser beam to completely cut one part of a piece within each pulse length.

Preferably, a digitally controlled installation, capable of making rapid movements and high accelerations in the initial phase will be used. The combination of a rapid relative movement with a long laser pulse length allows a relatively long cutting length to be achieved, for example between 10 and 50 millimetres, for each pulse.

By way of example, the relative speed between the part to be machined 4 and the laser head 8 is comprised between 10 and 50 metres per minute (m/min). It will be noted that the various parameters present, in particular the anticipated laser pulse length, relative movement speed and cutting length are dependent upon each other. Those skilled in the art will know how to adjust these parameters to each intended application to implement the laser cutting method according to the invention efficiently.

In a preferred variant of the method according to the invention, a high pressure gas, particularly oxygen, is supplied. The supply of high pressure gas is schematically represented by tube 16, through which a high pressure gas is brought into machining head 8 and exits as a jet through the aperture in the end nozzle 18 in head 8, through which the laser beam 12 also exits.

Evidently, those skilled in the art may combine movement of the machining head and movement of the machined part 4 in the same installation. These two movements are controlled so as to obtain a relative movement for making a given cut using a single pulse supplied by source 6. It will be noted that the machined part may have any type of surface not just a plane surface as shown in FIGS. 1 and 2. The surface which is cut may for example be cylindrical. In such case, part 4, or machining head 8, or both, undergo a vertical movement. Evidently, the vertical movement along the vertical axis is synchronised with movements in the horizontal plane.

FIG. 2 shows another embodiment of a laser installation 20 for implementing the method according to the invention. Those references that were described above will not be explained in detail here. Installation 20 includes an scanner type optical device, schematically represented by two mirrors 21 and 22 that can be oriented to vary the horizontal position of laser beam 12 supplied by source 6, so that it describes or follows a line along a predetermined cutting contour on part 4, which in FIG. 2 is a circle 15, for machining aperture 14.

The dimensions of machining head 9 are sufficient so that the aperture in end nozzle 19 has dimensions corresponding to the desired contour 15. More specifically, the machining head has a nozzle with an outlet aperture for said laser beam and for a working gas whose external contour approximately matches the cutting contour, to enable the laser beam to exit the nozzle by following said line along the cutting contour.

For circular cuts, a rotating optical system is used, which makes the beam slightly oblique and causes it to rotate rapidly. All of the other elements remain stationary, which allows circular machining to be performed at very high speed. Thus, in the present case, the machined part 4 can remain in a stationary position and only the optical device (21, 22) moves so that the laser beam follows a desired cutting line entirely with each laser pulse. This allows high cutting speeds to be easily produced.

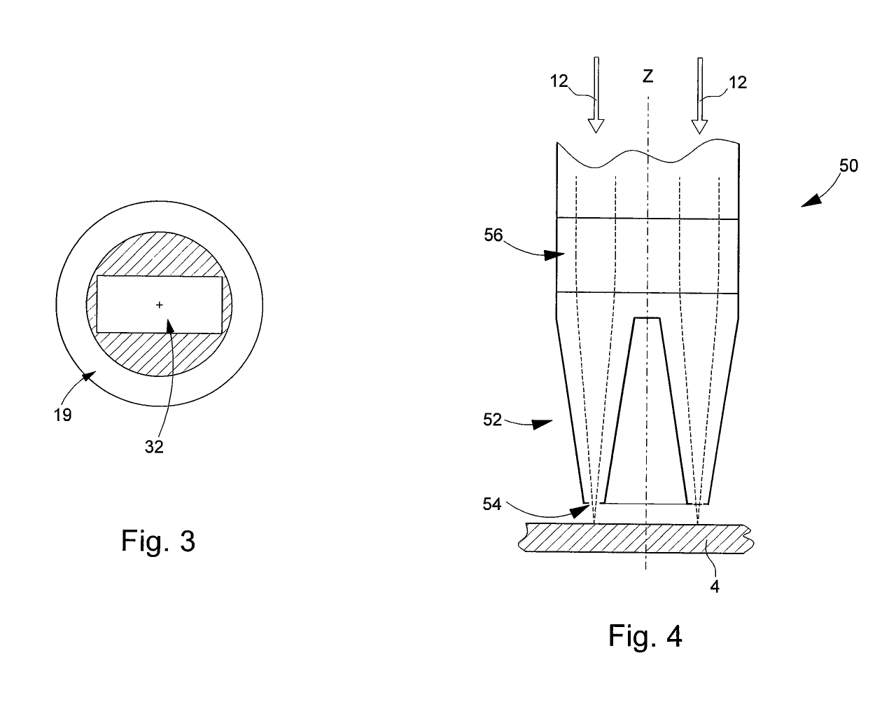

FIG. 3 shows a variant of nozzle 19 provided in the installation of FIG. 2 (of the scanner type) for rectangular cuts. Thus, laser beam 12 is required to undergo a movement along a rectangular contour in the horizontal plane at each laser pulse, without the machining head itself having to be moved synchronously. Therefore, the end nozzle has an aperture 32, whose shape matches the desired cutting contour in the parts to be machined. A slot can simply be made in the case of a rectilinear sweep or a sweep along any line.

When contour 15 has a relatively large diameter, a machining head with a nozzle 19 that has an aperture like in FIG. 3 raises a problem as regards providing a working gas with sufficient pressure. In such case, the present invention proposes making a machining head 50 with an end nozzle 52 that has a circular slot 54, as shown schematically in FIG. 4. Nozzle 52 has axial symmetry here along axis Z. It should be noted that the exit slot for the laser beam and working gas may define any contour that matches the determined cutting contour. The surface of the slot is relatively small so that the working gas pressure can remain sufficient in the gas jet localised on the cutting contour. An F-Theta type focussing lens 56, which focuses in the same plane perpendicular to its optical axis will preferably be used.

To implement the method according to the invention, by way of alternative, those skilled in the art could also use a laser installation wherein the machining head is connected to the laser source by an optical fibre.

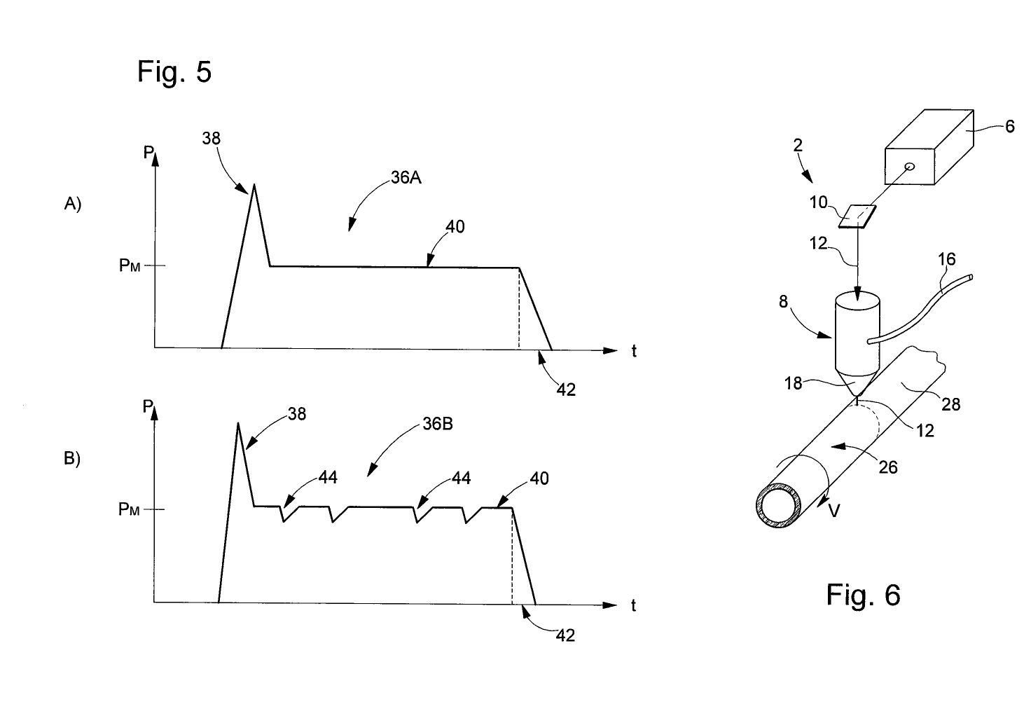

According to a preferred implementation of the invention, each laser pulse has an initial power peak 38 for making an initial piercing in the part to be machined. This power peak is appropriate where cutting does not start from one edge of the part. Two laser pulse power profile variants according to the invention are shown schematically in FIGS. 5A and 5B. Laser pulse 36A includes an initial power peak 38 followed by a pulse body 40 with much lower power than the maximum power of peak 38. The power of pulse body 40 approximately matches the mean power P_{M} of pulse 36A. It should be noted that pulse body 40 has constant power until its end part where it finishes with a steep, but not vertical profile. This end part of the pulse corresponds to the stop phase of the relative movement between the laser machining head and the machined part. In the stop phase, this particular feature provides an approximately equal supply of energy per cutting millimetre to the amount of energy per millimetre supplied at the nominal relative speed. Pulse 36A is provided particularly for circular or elliptical cutting.

According to a variant of the pulse profile, the pulse body 40 can also have a variable profile before the stop phase, according to the cutting line, particularly when the lines has curves of small radius where it is advantageous to reduce the power of the pulse to limit the quantity of energy supplied to this region. FIG. 5B shows schematically a variant suited to machining a rectangular profile. In this case, pulse 36B has a pulse body 40 with power dips 44 corresponding to passages through the four corners of the rectangle. This provides a constant energy supply per relative unit of movement also in the corners where the change of direction can briefly slow down the relative movement speed between the laser beam and the machined part. The end length 42 of the stop phase is less than that of FIG. 5A, which corresponds to a greater deceleration in the relative movement in the end of cutting phase.

FIG. 6 shows another application of the cutting method according to the invention. Laser installation 2 is similar to that shown in FIG. 1. This installation is used for cutting tubes 28. Each cut of a part 26 of tube 28 is performed using a single laser pulse, whose length is selected in accordance with the rotational speed V at which tube 28 is being driven and also the diameter of the tube. Rotational speed V will depend in particular upon the material forming the wall of tube 28 and the thickness of the wall to be cut.

The mean pulse power is also a parameter to be considered. By way of example, with a mean power P_{M}=400 W for each laser pulse and a 0.3 millimetre stainless steel wall, it is possible to perform cutting at a speed of up to 30 m/min. By way of example, in these conditions, a pulse length of 50 ms can cut a length of approximately 25 millimetres. Thus, using a single pulse, a tube with a diameter of approximately 8 millimetres can be cut. Very clean cutting is thus achieved with a flat lateral wall.

1-10. (canceled)

11. A method of cutting a part using a pulsed laser providing a laser beam formed of laser pulses, wherein each cut in said part is made entirely by a single laser pulse during a relative movement between said part and said laser beam at a speed of the order magnitude of ten metres per second or more, the length of said pulse being more than a millisecond and sufficiently long as a function of said relative movement for said laser beam to travel at least the length of said cut during said single laser pulse.

12. The cutting method according to claim 11, wherein it is implemented using a scanner type optical device or a rotating optical system for making the laser beam undergo a rapid movement during each pulse so that said beam follows a line along a predetermined cutting line or contour on said part.

13. The cutting method according to claim 12, wherein it is implemented using a machining head that does not undergo any horizontal movement, said machining head having a nozzle that has an exit aperture for said laser beam and a working gas whose external contour approximately matches said cutting contour to enable the laser beam to exit said nozzle by following said line along said cutting contour.

14. The cutting method according to claim 13, wherein said machining head includes a nozzle that has a slot, which defines a contour that matches the intended cutting contour.

15. The cutting method according to claim 11, wherein said part is a tube and in that the cut made by the same single laser pulse consists in cutting a part of said tube.

16. The cutting method according to claim 11, wherein an initial piercing is necessary to perform said cut and wherein said laser pulse includes an initial power peak for making said initial piercing in said part.

17. The cutting method according to claim 16, wherein said initial power peak is followed by a pulse body that has a power profile which varies in a accordance with the relative speed of said relative movement.

18. The cutting method according to claim 17, wherein said power profile includes an end part with a negative slope whose value is determined as a function of the deceleration in the stop phase of the relative movement.

19. The cutting method according to claim 17, wherein said power profile is determined so as to provide a constant energy supply per unit of relative movement, so that said supply is uniform along the cutting line or contour.

20. The cutting method according to claim 11, wherein the length of said laser pulses is between approximately 10 and 100 milliseconds and the relative speed of said relative movement is between around 10 and 50 metres per minute.
